(19) United States
(12) Patent Application Publication
(10) Pub. No.: US 2018/0326950 A1
(43) Pub. Date: Nov. 15, 2018

(54) Cleaning Machine for Shopping Carts

(71) Applicant: Robert Sturgill, Spring, TX (US)

(72) Inventor: Robert Sturgill, Spring, TX (US)

(21) Appl. No.: 15/593,299

(22) Filed: May 11, 2017

(51) Int. Cl. B60S 3/00; B08B 3/02; B08B 3/08

(52) U.S. Cl. CPC B60S 3/002; B08B 3/08; B08B 3/02

(57) ABSTRACT

The current invention is a washing systems that allow a user to quickly and thoroughly wash one or multiple shopping carts. The cart washing system has plastic hanging curtains at the entrance, exit, and between the washing and drying chambers. The washing chamber is first and has a pressurized overhead spraying arm, distributing water and cleaning solutions at approximately 1600 psi. The drying chamber has an overhead high heat drier bar, immediately before the exit. The machine can be set for single or multiple carts, with different amounts of cleaning solutions based on number of carts. The plumbing will be supplied through plastic of metal tubing.

### CROSS-REFERENCES TO RELATED APPLICATIONS (IF ANY)

None.

### BACKGROUND

### 1. Field of the Invention

This invention relates to machines that are designed to wash items and particularly ones that are made for washing shopping carts.

### 2. Description of Prior Art

Many stores provide shopping carts to assist customers. This allows consumers to safely move greater weight and bulk of purchases safely while shopping, but increases the potential for spreading germs. Many stores have protocols, or contract with cleaners, to periodically clean shopping carts. Existing methods include hand wiping, stem wand cleaning and steam cleaning, and a single-cart push-through machine.

There is still room for improvement in the art.

### SUMMARY OF THE INVENTION

The current invention is a device and process that can wash single or multiple shopping carts, using high pressure water and cleaning chemicals, and a high heat blow drier.

The washing device will be in a rectangular box shape, with the thinner sides being for the entrance and exit of shopping carts. The frame and walls would be made of a hard, durable material, such as metal or hard plastic. The frame design is 6061 angle aluminum with dimensions of 48″ tall, 24″ wide, and 60″ long. The entrance and exit have plastic curtains covering them.

The washing device would power wash the carts with 1,600 psi using a liquid of water and cleaning solutions distributed from an overhead spraying arm. Between “washing” and “drying” areas, there are plastic curtains hanging, with a cut-out to accommodate a cart passing with minimal contact. Before existing, the cart is dried off by an overhead high heat drier.

### BRIEF DESCRIPTION OF THE DRAWINGS

Without restricting the full scope of this invention, the preferred form of this invention is illustrated in the following drawings:

FIG. 1 shows the cart cleaning device;

FIG. 2 shows a rendering (entrance is on the right); and

FIG. 3 shows another rendering

### DESCRIPTION OF THE PREFERRED EMBODIMENT

There are a number of significant design features and improvements incorporated within the invention.

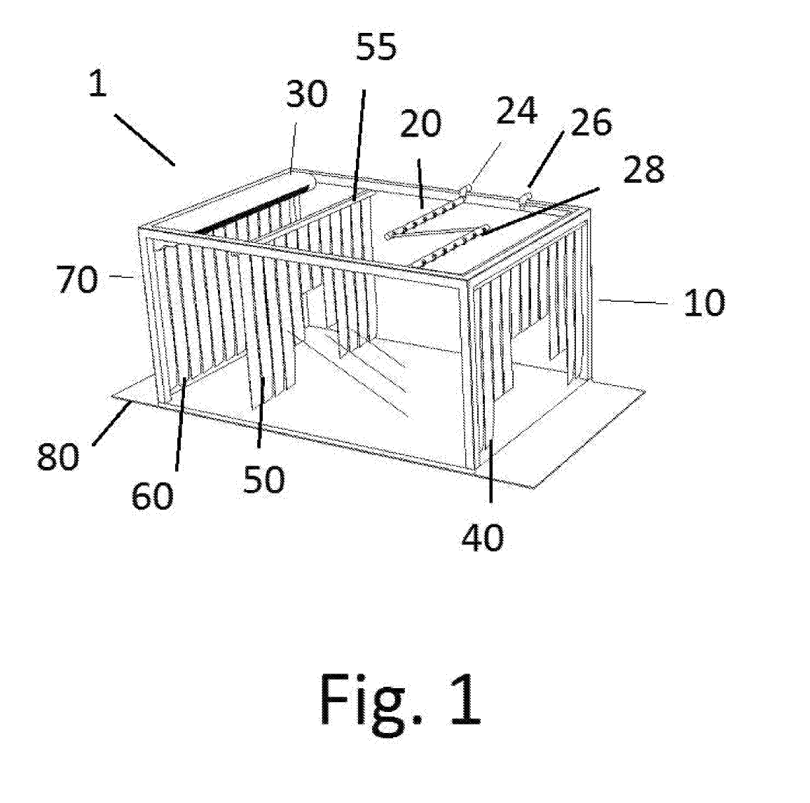

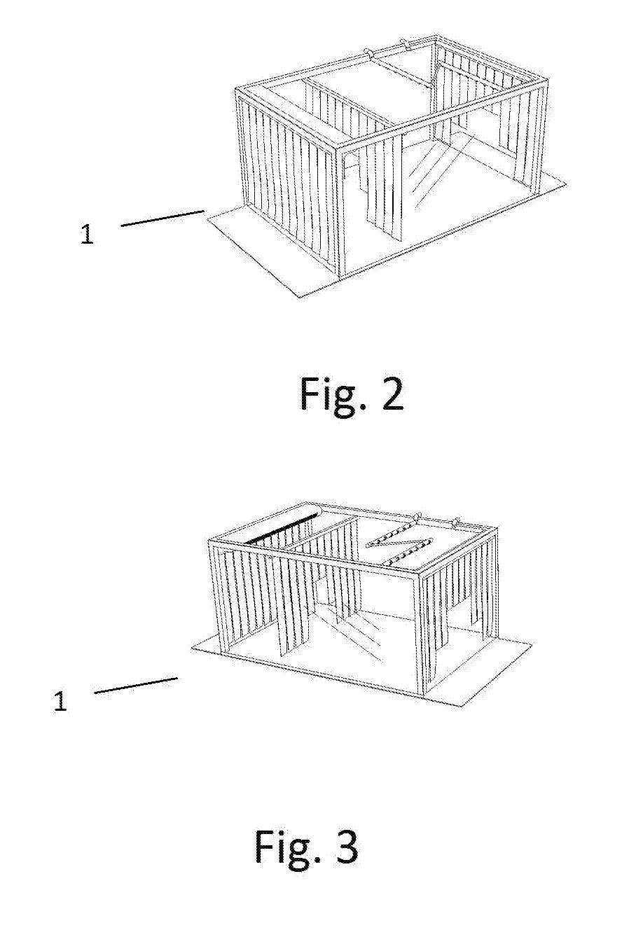

As shown in FIGS. 1 through 3, the current invention is a device 1 that can wash single or multiple shopping carts, using high pressure water and cleaning chemicals, and a high heat blow drier.

The washing device 1 will be in a rectangular box shape, with the thinner sides being for the entrance and exit of shopping carts. The frame and walls would be made of a hard, durable material, such as metal or hard plastic. The frame design, in the preferred embodiment, is 6061 angle aluminum with dimensions of 48″ tall, 24″ wide, and 60″ long. The walls are to be made of ABS or similar plastic sheets, with dimensions of 48″×60″×0.25″ for the longer sides. In the preferred embodiment, the device 1 would have a floor 80 or a floor covering

The washing device 1 would have a washing area where it power washes the carts with 1,600 psi liquid with a water and cleaning solution distributed from an overhead spraying arm 20. Plumbing would be through metal or plastic lines with an input line 24 and output line 26. The spraying would be out of the spraying nozzles 28 that would be located at the bottom of the spraying arm 20. The spraying arm 20 is located at the top of the device 1.

Before existing, the cart is dried off in a drying area by an overhead high heat drier 30 that is located at the top end of the cleaning device 1. The heat drier 30 is hung from the top of the device 1 with the air blowing down over the washed cart.

The entrance and exit have plastic curtains which are made of parallel strips in the preferred embodiment. Between “washing” and “drying” areas, there are plastic curtains hanging, with a cut-out to accommodate a cart passing with minimal contact. There is one entre cut-out in the first curtain 10 at the beginning of the device 1. There is a center cut-out in the second curtain 50 in the middle of the device 1 which hangs from a rod 55 at the top of the device 1. There is an exit curtain 60 at the exit 70 of the device 1 which does not have a cut-out section.

Operation

When the shopping carts are ready for cleaning the cleaning device is turned on. The whole process will take under three minutes and leave the carts sanitized and sparkling clean. The jet sprays 28 sprays and cleans that shopping carts that blast through the germs and high heat blowers 30 dries the carts in seconds. The device 1 can extend to clean multiple carts and compresses when washing just one or two.

In the preferred embodiment that frame is made out of 6061 angle aluminum.

Advantages

The innovative cart washing system makes cleaning shopping carts quick and easy. Current approaches include hand cleaning or using stem wand sprayers, as well as a cart cleaning system that can clean one cart at a time. This cart washing system will allow a user to clean one or multiple carts, in approximately 3 minutes. The system allows thorough and consistent cleaning, to provide routine cleaning, but simple and quick enough to handle a single dirty cart. By improving cart cleaning, cart life can be extended for years.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A shopping cart cleaning device comprising;
A frame with an entrance and exit with a washing area and a drying area where there is an entrance curtain in the entrance and an exit curtain in the exit where the washing area has a sprayer that sprays the carts and the drying area has a dryer that dries the carts.

2. The device of claim 1 further comprising;
Having a curtain between the washing area and the drying area.

3. The device of claim 1 further comprising;
Having a floor at the bottom of the frame.

4. The device of claim 1 further comprising;
Having walls as part of the frame.

5. The device of claim 1 further comprising;
Having the sprayer spray a mixture of water and cleaning solution.

6. The device of claim 1 further comprising;
Having the sprayer located at the top of the frame.

7. The device of claim 1 further comprising;
Having the heater located at the top of the frame.

8. The device of claim 1 further comprising;
Having the frame be rectangular in shape.

9. The device of claim 1 further comprising;
Having the frame be made of aluminum.

10. The device of claim 1 further comprising;
Having the sprayer be a spraying arm connected to an input and output.

11. A process to clean shopping carts comprising;
Using a device with a frame with an entrance and exit with a washing area and a drying area where there is an entrance curtain in the entrance and an exit curtain in the exit where the washing area has a sprayer that sprays the carts and the drying area has a dryer that dries the carts.

12. The process of claim 11 further comprising;
Having a curtain between the washing area and the drying area.

13. The process of claim 11 further comprising;
Having a floor at the bottom of the frame.

14. The process of claim 11 further comprising;
Having walls as part of the frame.

15. The process of claim 11 further comprising;
Having the sprayer spray a mixture of water and cleaning solution.

16. The process of claim 11 further comprising;
Having the sprayer located at the top of the frame.

17. The process of claim 11 further comprising;
Having the heater located at the top of the frame.

18. The process of claim 11 further comprising;
Having the frame be rectangular in shape.

19. The process of claim 11 further comprising;
Having the frame be made of aluminum.

20. The process of claim 11 further comprising;
Having the sprayer be a spraying arm connected to an input and output.
